(19) United States
(12) Patent Application Publication
(10) Pub. No.: US 2022/0138554 A1
(43) Pub. Date: May 5, 2022

(54) SYSTEMS AND METHODS UTILIZING MACHINE LEARNING TECHNIQUES FOR TRAINING NEURAL NETWORKS TO GENERATE DISTRIBUTIONS

(71) Applicant: CAPITAL ONE SERVICES, LLC, McLean, VA (US)

(72) Inventors: Austin WALTERS, Savoy, IL (US); Jeremy GOODSITT, Champaign, IL (US); Anh TRUONG, Champaign, IL (US)

(73) Assignee: CAPITAL ONE SERVICES, LLC, McLean, VA (US)

(21) Appl. No.: 17/086,131

(22) Filed: Oct. 30, 2020

(51) Int. Cl. G06N 3/08; G06N 3/04; G06F 16/25

(52) U.S. Cl. CPC G06N 3/08; G06F 16/258; G06N 3/04

(57) ABSTRACT

Systems and methods utilizing machine learning techniques for training neural networks to generate distributions. A system includes at least one processor and a storage medium storing instructions that, when executed cause the at least one processor to perform operations including receiving and sending a dataset to an encoder layer of a neural network; compressing and organizing the dataset by the encoder layer to produce latent variables; sending the latent variables to a recurrent layer of the neural network; and updating a memory of an at least one LSTM cell based on the latent variables. The operations also include generating edge values of bins for the latent variables by the recurrent layer; sending the latent variables and generated edges and bins to a decoder layer of the neural network; and producing an output matrix and reconstructing the distribution from the output matrix by the decoder layer of the neural network.

### TECHNICAL FIELD

The present disclosure generally relates to computerized systems and methods utilizing machine learning techniques for training neural networks to generate distributions. In particular, embodiments of the present disclosure relate to inventive and unconventional systems for generating an estimated distribution from a dataset. For example, embodiments of the present disclosure may use machine learning techniques to generate histograms to understand the distribution of a new data set or a stream and/or create synthetic data that matches that distribution.

### BACKGROUND

Currently if one wants to generate a distribution from a dataset, it is necessary to process the entire dataset. Algorithms for processing large datasets are extremely complex, and can require significant amounts of time and computing resources.

Estimation is one way to reduce the overhead and speed up the processing of large datasets. Estimation methods that exist today are able to take two datasets and merge them to create a histogram. This is achieved by manually creating “bins”, that is, collections of dataset members divided into groups, according to their values. The result is a distribution of values in the datasets, that may be presented as a matrix. Then, if a new dataset is added, the method will either have to (1) create additional bins where values of the two datasets are merged, e.g. merging two histograms together by manipulating the bins, or (2) begin the process from the start, recreating all the bins from scratch.

Current methods exhibit a number of problems. Large datasets take significant amount of time to merge. Recreating or regenerating buckets takes longer the larger the datasets become. The computing resources required to perform these computations become larger and efficiency of the existing approach suffers as a result.

Therefore, there is a need for improved methods and systems for efficient generation of distributions.

### SUMMARY

One aspect of the present disclosure is directed to a system for generating a distribution, including at least one processor; and at least one non-transitory memory storing instructions that, when executed by the at least one processor cause the system to perform operations. The operations include receiving a dataset and, if the dataset includes other than integer values or floating point values, converting the dataset to consist only of integer values and floating point values. The operations further include sending the dataset to an encoder layer of a neural network, compressing and organizing the dataset by the encoder layer to produce latent variables, and sending the latent variables to a recurrent layer of the neural network. The operations also include updating, by the recurrent layer, a memory of an at least one LSTM cell based on the latent variables; generating edge values of bins for the latent variables by the recurrent layer; sending the latent variables and generated edges and bins to a decoder layer of the neural network; and producing an output matrix, having a plurality of elements, by decoding the latent variables by the decoder layer of the neural network. The operations further include reconstructing the distribution from the output matrix by the decoder layer of the neural network.

Another aspect of the present disclosure is directed to a system for generating a distribution, including at least one processor and at least one non-transitory memory storing instructions that, when executed by the at least one processor cause the system to perform operations. The operations include receiving a dataset having a plurality of samples and receiving a specified number of bins. The operations also include sending the dataset and the specified number of bins to a multilayer neural network; and generating, by the neural network, a first dimension of an output matrix comprising the specified number of bins. The operations further include calculating, by the neural network, edge values for the specified number of bins, such that the bins do not overlap; generating, by the neural network, a second dimension of the output matrix comprising the edge values of the bins; calculating, by the neural network, numbers of the sample values in the bins, based on edge values of the bins. The operations additionally include generating, by the neural network, a third dimension of the output matrix comprising the numbers sample values in the bins. The operations also include producing, by the neural network, the final output matrix; and reconstructing, by the neural network, the distribution from the output matrix.

Yet another aspect of the present disclosure is directed to a method for generating a distribution including receiving a dataset comprising integer values, floating point values, and a specified number of bins. The operations include sending the dataset and the specified number of bins to an encoder layer of a neural network. The operations further include producing latent variables by compressing and organizing the dataset by the encoder layer; and sending the latent variables to a recurrent layer of the neural network. The operations also include generating, by the recurrent layer, edge values of the bins for the latent variables of the neural network. The operations further include sending the latent variables and generated edge values to a decoder layer of the neural network; producing an output matrix by decoding the latent variables by the decoder layer. The operations also include reconstructing the distribution from the output matrix by the decoder layer.

Other systems, methods, and computer-readable media are also discussed herein.

### DESCRIPTION OF THE DRAWINGS

The drawings are not necessarily to scale or exhaustive. Instead, emphasis is generally placed upon illustrating the principles of the embodiments described herein. The accompanying drawings, which are incorporated in and constitute a part of this specification, illustrate several embodiments consistent with the disclosure and, together with the description, serve to explain the principles of the disclosure. In the drawings:

FIG. 1 is a schematic block diagram illustrating an exemplary embodiment of a system performing training of the neural network and/or generation of a distribution.

FIG. 2 is a schematic block diagram illustrating an exemplary embodiment of a multilayer neural network for generating a distribution, consistent with the disclosed embodiments.

FIG. 3 is a histogram illustrating an exemplary embodiment of a distribution produced by the multilayer neural network, consistent with the disclosed embodiments.

FIG. 4 is a flow chart of an exemplary method for generating a distribution, consistent with the disclosed embodiments.

FIG. 5 is a flow chart of another exemplary method for generating a distribution, consistent with the disclosed embodiments.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

Distribution of data values in a dataset may be represented as a histogram. Produced distribution may be an estimation, which may be used as representation of the data where accuracy is not as important as processing speed, for example in a mobile application. A practical example would be temperature readings from a large number of meteorological stations creating a large number of samples. The data may be presented as a histogram representing a large number of samples, and may be delivered live to a mobile device. However, with the current methods, a mobile device may be unable to process such a large dataset, and even if it were able to process it, significant amounts of time and computing resources would be required to display a result.

Many industries may require processing of large datasets on a daily basis for making crucial decisions. For example, banks must process FICO credit scores of thousands of customers on a daily basis, and make credit decisions based on this information. Distributions of FICO scores are variable, and it is in the banks' best interest to have relevant and accurate information on hand on a moment's notice. Again, existing systems fail to deliver timely result without using enormous amount of processing power. Therefore, there is a need for improved methods and systems for efficient generation of distributions.

Embodiments of the present disclosure are directed to systems and methods configured for generating a distribution.

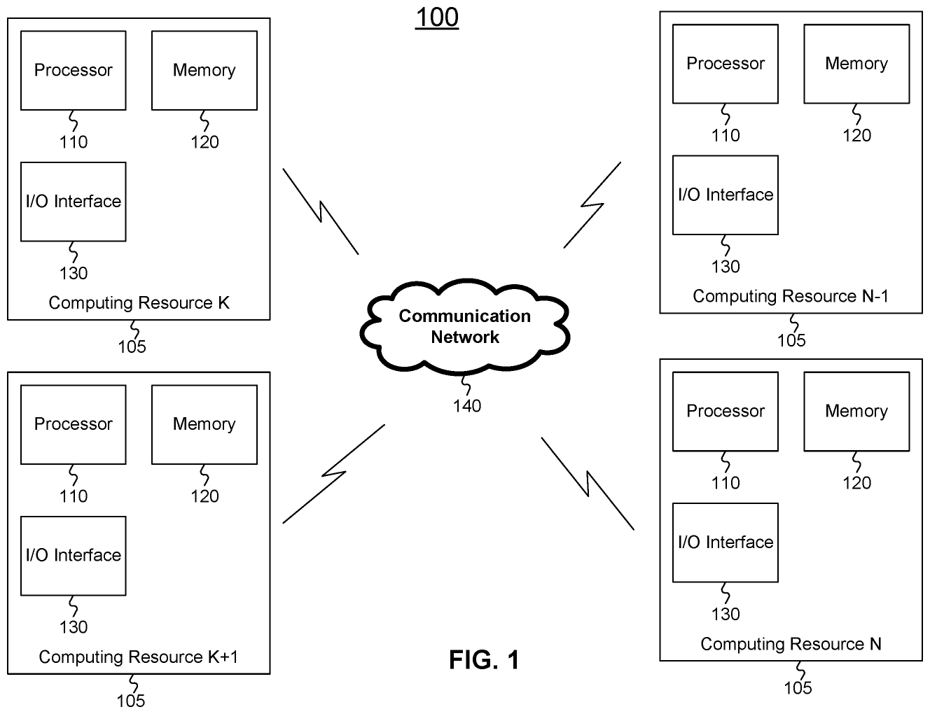

FIG. 1 depicts a schematic block diagram 100 illustrating an exemplary embodiment of a system for training of a neural network and generation of a distribution of values in a dataset. As illustrated on FIG. 1, system 100 may include a variety of components, and subsystems each of which may be connected to one another. System 100 is not limited to the depicted exemplary embodiment and may comprise additional computerized systems, working in tandem, and connected via network 140. The systems may also be connected to one another via a direct connection, for example, using a cable.

System 100 comprises at least one computing resources 105 comprising a processor 110. Processor 110 may comprise a microprocessor, including a central processing unit (CPU), a graphics processing unit (GPU), or other electronic circuitry capable of carrying out the instructions of a computer program by performing the operations specified by instructions stored in a memory 120. Alternatively, or concurrently, processor 110 may comprise one or more special-purpose devices built according to embodiments of the present disclosure using suitable circuit elements, e.g., one or more application-specific integrated circuits (ASICs), field-programmable gate arrays (FPGAs), or the like. Memory 120 may comprise volatile memory, such as random-access memory (RAM), a non-volatile memory, such as a hard disk drive, a flash memory, or the like, or any combination thereof.

Computing resource 105 further comprises an I/O interface 130. I/O interface 130 may comprise any suitable hardware or software solution for input/output of data. I/O operations are accomplished through a wide assortment of external devices that provide a means of exchanging the data via inputs and outputs between the external environment and computing resource 105.

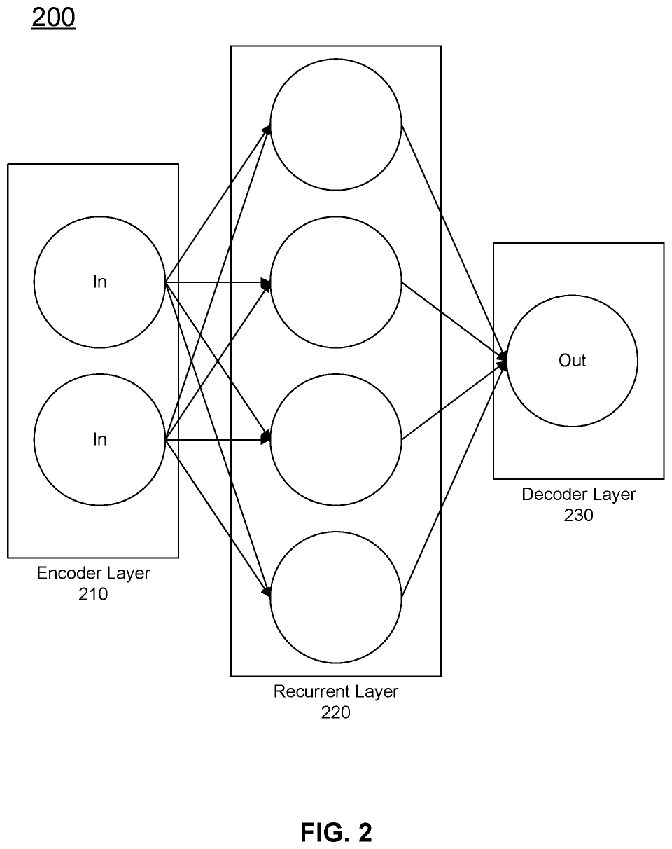

System 100 further comprises a communication network 140. Network 140 may be any type of network that facilitates communications and data transfer between components of system environment. Network may be a Local Area Network (LAN), a Wide Area Network (WAN), such as the Internet, and may be a single network or a combination of networks. Further, network 140 may reflect a single type of network or a combination of different types of networks, such as the Internet and public exchange networks for wireline and/or wireless communications. Network 140 may use cloud computing technologies. Network is not limited to the above examples and system 100 may implement any type of network that allows the components and entities (not shown) included in FIG. 1 to exchange data and information. A multilayer neural network 200, as further depicted on FIG. 2, may completely or partially reside on computing resources 105 of system 100.

FIG. 2 depicts a schematic block diagram illustrating an exemplary embodiment of a multilayer neural network for generating a distribution. Neural network 200 may comprise an encoder layer 210, recurrent layer 220, and a decoder layer 230. Encoder layer 210 may be an input layer preparing latent variables for further processing in recurrent layer 220. Recurrent layer 220 may be a hidden layer comprising a recurrent neural network (RNN) with long short-term memory (LSTM) architecture or gated recurrent unit (GRU) architecture. Recurrent layer 220 may be configured to generate bin edge values for the distribution, that is, the maximum and minimum dataset values that will be contained in each bin. Recurrent layer 220 then passes the bin edge values on to the decoder layer 230. Decoder layer 230 may be an output layer configured to reconstruct the distribution.

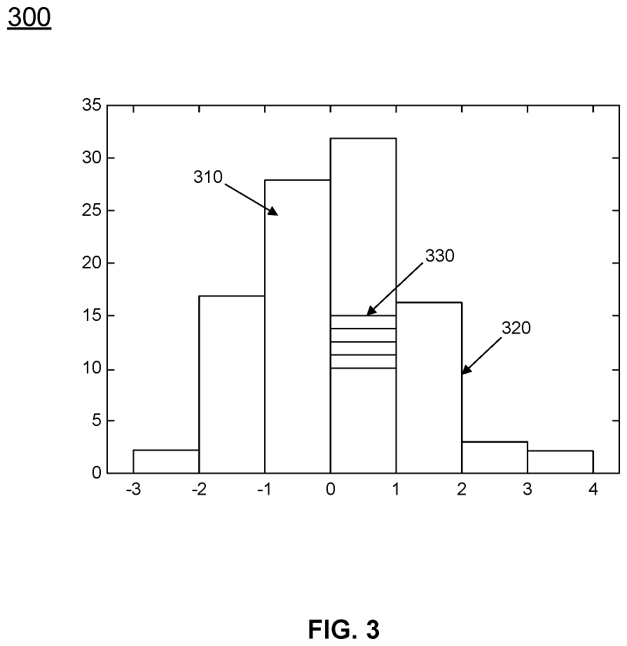

FIG. 3 depicts a histogram 300 illustrating an exemplary embodiment of a distribution produced by the multilayer neural network. The dataset represented by histogram 300 includes a plurality of sample values 310, grouped into bins 320 defined by bin edges 330. Sample values 310, bins 320, and bin edges 330 comprise an output matrix produced by the decoder as discussed later in the disclosure. Histogram 300 is one of many examples by which an output matrix of a dataset can be visually represented.

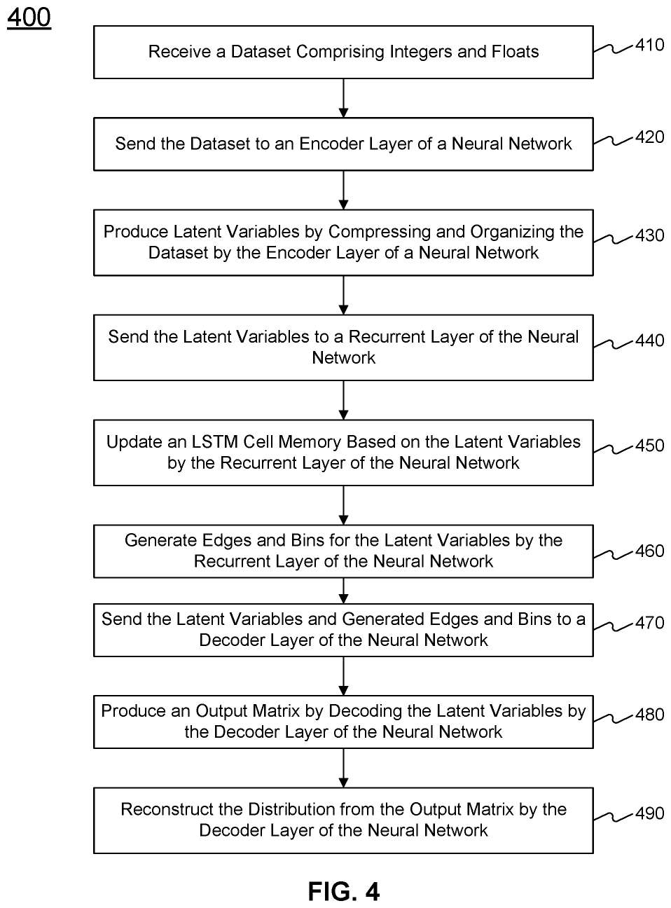

FIG. 4 is a flow chart of a process 400 for generating a data distribution using a multilayer neural network. Process 400 starts at step 410 by receiving a dataset. The dataset may be segmented, with each segment represented by a latent matrix generated by an auto-encoder. The segmented dataset may then be passed to the RNN. For example, a dataset or column having a length X may be split it into Y segments. The segments may be used to later generate a histogram of X by feeding all the Y segments to the RNN. The dataset may comprise integer values, floating point values, or a combination thereof. In the event the received dataset includes values other than integer and/or floating point values, the dataset values may be converted into integer values and floating point values. For example, values which may be categorized will be converted in such a way that integer values are assigned to each category. Another example is a dataset representing an image. The image may be converted to pixels, with the pixels being presented as integer values representing luminance and chrominance values.

Process 400 then proceeds to step 420. In step 420, system 100 sends the dataset received in step 410 to an encoder layer of a neural network. The encoder layer may be located within same system. Alternatively, the encoder layer may be located at an external system coupled to the main system and connected via communications network 140 (FIG. 1). Communication may be performed using I/O interface 130. If the dataset is exceptionally large, the dataset may be partitioned and sent for processing in batches of a preset size, the size depending on the processing power of system 100.

Process 400 then proceeds to step 430, where the encoder layer of the neural network compresses the dataset. For this process to be efficient, the encoder layer must perform an efficient compression of the data into a lower-dimensional space and further organize the dataset to produce latent variables, that is, variables that are not directly observed or measured but are rather inferred (through a mathematical model) from other variables that are directly observed or measured.

Process 400 then proceeds to step 440, where, system 100 sends the latent variables to a recurrent layer of the neural network (RNN). The recurrent layer may be located within same system or, alternatively, may be located at an external system coupled to the main system and connected via communications network 140. LSTM architecture of an RNN may be used.

Process 400 then proceeds to step 450, where the RNN updates “memory” of an LSTM cell from latent variables of the dataset received from the encoding layer. GRU cells may also be used. The LSTM/GRU cells are built earlier as part of the selected RNN architecture, by a training process. The LSTM/GRU cells may be trained as part of step 450, with the RNN taking the latent variables as input to the model. The latent variables may be taken by the RNN, frame-after-frame, adjusting the model accordingly. Every frame of the dataset sent to the model thus updates the memory of the LSTM or GRU cell.

At step 460, the recurrent layer generates bin edge values for bins containing the latent variables. The edge values define data ranges for the bins and may be changed to minimize the overall error of approximating the original distribution. The edge values may define different bin widths, that is data ranges for sample values contained in the bins.

Process 400 then proceeds to step 470, where system 100 sends the latent variables and bin/edge values to a decoder layer of the neural network. The decoder layer may be located within system 100, or, alternatively, may be located within an external system coupled to system 100 and connected via communications network 140.

Process 400 then proceeds to step 480, where the decoder layer of the neural network produces an output matrix by decoding the latent variables. The output matrix may be multidimensional, wherein a first dimension of the output matrix may comprise the number of bins, a second dimension of the output matrix may comprise bin edge values, and a third dimension of the output matrix may comprise the number of samples in each bin.

Process 400 then proceeds to step 490, where the decoder layer of the neural network reconstructs a distribution from the output matrix, the reconstructed distribution being an estimate with an accuracy based on a preset confidence parameter and being represented as a histogram.

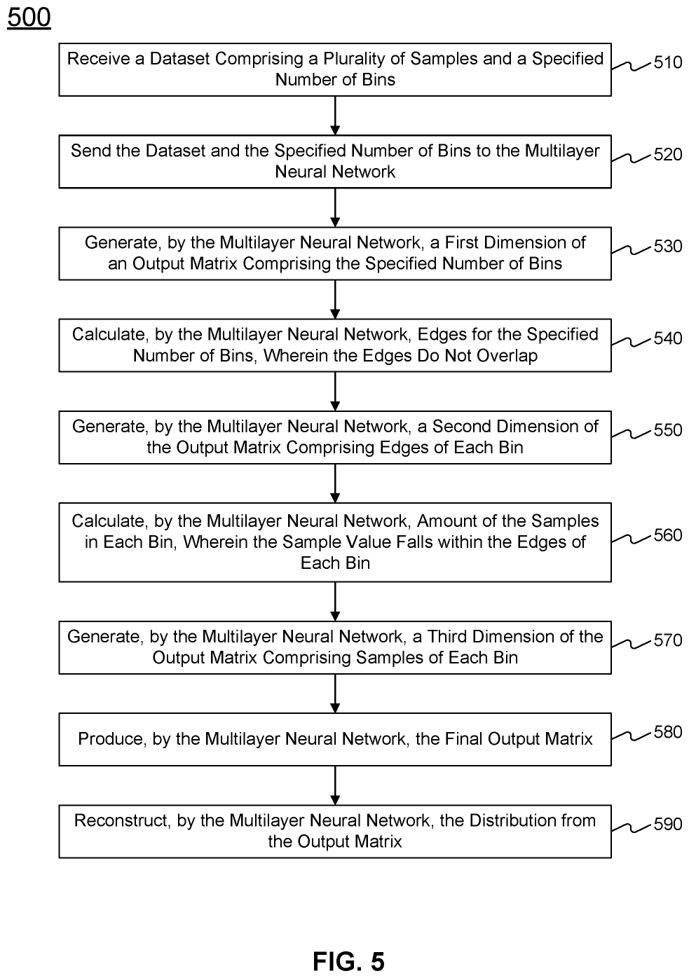

FIG. 5 illustrates an outline of another process 500 for generating a distribution using multilayer neural network. While process 400 of FIG. 4 described a process within each layer of multilayered neural network 200 (FIG. 2), process 500 illustrates the operation of multilayer neural network 200 as a whole. Process 500 starts at step 510 with receiving a dataset and a specified number of bins. The dataset may comprise integer values, floating point values, or a combination thereof. If the received dataset contains values other than integer values and floating point values, the dataset values may be converted such that all dataset values are integer values or floating point values.

Process 500 then proceeds to step 520, where system 100 sends the dataset received in step 510 to multilayer neural network 200. As with process 400, if the dataset is exceptionally large, it may be partitioned and sent for processing in batches of preset size.

Process 500 then proceeds to step 530, where multilayer neural network 200 generates a first dimension of an output matrix comprising the specified number of bins. The number of bins may be preset or alternatively derived by multilayer neural network 200 based on the parameters of the original dataset.

Process 500 then proceeds to step 540, where multilayer neural network 200 calculates edge values for the specified number of bins, such that the bins do not overlap. The edge values define data ranges for samples of each bin. Bins may have different bin widths.

Process 500 then proceeds to step 550, where multilayer neural network 200 generates a second dimension of the output matrix comprising edge values of each bin. The second dimension of the output matrix may comprise edge values such that all bins have a single bin width or multiple bin widths. When the second dimension defines a range of bin widths, the range defines both minimum and maximum values of samples in each bin. In the event the second dimension is a single value, bin edge values are defined only by a maximum edge value in series and bins start at a preset point (for example zero, center of coordinates). For example, if an edge value for the first bin is determined to be 1, the bin boundaries for the first bin would be 0 and 1, and the next bin in series will have boundaries starting from 1 (determined edge of the first bin) to the next determined edge value.

Process 500 then proceeds to steps 560, where multilayer neural network 200, calculates the number of sample values in each bin, that is, the number of sample whose values fall within edge values of each bin. The amount is calculated by comparing values of each variable to the previously determined edge values. Thus. if the value of the sample is below a maximum edge value and above a corresponding minimum edge value, the sample value will be assigned to the bin corresponding to these edge values.

Process 500 then proceeds to step 570, where multilayer neural network 200 generates a third dimension of the output matrix comprising the determined number of sample values in each bin. The third dimension is populated based on number of bins in the first dimension and bin widths in the second dimension.

Process 500 then proceeds to step 580, where multilayer neural network 200 produces the final output matrix, comprising at least three previously generated dimensions. Error checking and verification may be performed at this step as well.

In summary steps 530, 550, 570 generate dimensions for the output matrix, while steps 540 and 560 calculate corresponding values for each of the generated dimensions, consistent with earlier disclosure. Finally step 580 produces the final output matrix by combining all of the generated dimensions populated with the calculated data.

Process 500 then proceeds to step 590, where multilayer neural network 200 reconstructs a distribution from the output matrix, the reconstructed distribution comprising an estimate of accuracy based on a preset confidence parameter. The reconstructed distribution may be represented as a histogram. Other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims.

Processes 400 and 500 described on FIGS. 4 and 5 respectively may be utilized for training of autoencoders or variational autoencoders (VAEs) with a purpose of generating a distribution (e.g. a histogram). As used herein, an autoencoder is a type of artificial neural network used to learn efficient data coding in an unsupervised manner. As used herein, a variational autoencoder is a deep learning technique for learning latent representations. Unlike classical autoencoders, variational autoencoders are generative models. The association of the variational autoencoder with a classical autoencoder group of models derives mainly from the architectural affinity with the basic autoencoder (the final training objective has an encoder and a decoder), but their mathematical formulation differs.

Training may be performed until preset confidence parameter is met or the model has been trained for a set number of epochs, e.g. by recursively repeating training processes. As used herein, a confidence parameter is a parameter defining how close the estimate distribution is to the actual distribution. And as used herein an epoch refers to one cycle through the full training dataset. Usually, training a neural network takes more than a few epochs.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above-described examples, but instead are defined by the appended claims in light of their full scope of equivalents.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

It is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

The foregoing description is presented for purposes of illustration. It is not exhaustive and is not limited to the precise forms or embodiments disclosed. Modifications and adaptations of the embodiments will be apparent from consideration of the specification and practice of the disclosed embodiments.

Computer programs based on the written description and methods of this specification are within the skill of a software developer. The various programs or program modules can be created using a variety of programming techniques. One or more of such software sections or modules can be integrated into a computer system, non-transitory computer readable media, or existing software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application. These examples are to be construed as non-exclusive. Further, the steps of the disclosed methods can be modified in any manner, including by reordering steps or inserting or deleting steps. It is intended, therefore, that the specification and examples be considered as exemplary only, with a true scope and spirit being indicated by the following claims and their full scope of equivalents.

What is claimed is:

1. A system, comprising:
at least one processor; and
at least one non-transitory memory storing instructions that, when executed by the at least one processor cause the system to perform operations comprising:
receiving a dataset;
if the dataset includes other than integer values or floating point values, converting the dataset to consist only of integer values and floating point values;
sending the dataset to an encoder layer of a neural network;
compressing and organizing the dataset by the encoder layer to produce latent variables;
sending the latent variables to a recurrent layer of the neural network;
updating, by the recurrent layer, a memory of an at least one LSTM cell based on the latent variables;
generating edge values of bins for the latent variables by the recurrent layer;
sending the latent variables and generated edges and bins to a decoder layer of the neural network;
producing an output matrix, having a plurality of elements, by decoding the latent variables by the decoder layer of the neural network; and
reconstructing a distribution from the output matrix by the decoder layer of the neural network.

2. The system of claim 1, wherein the operations further comprise constructing a distribution matrix from the dataset.

3. The system of claim 2, wherein the operations further comprise comparing the reconstructed distribution with the constructed distribution.

4. The system of claim 3, wherein comparing the reconstructed distribution comprises comparing each element of the output matrix with the constructed distribution matrix.

5. The system of claim 4, wherein the operations further comprise calculating a confidence parameter based on the comparison of the elements of the output matrix with the constructed distribution matrix.

6. The system of claim 5, wherein operations are recursively repeated until a desired confidence parameter is met to train one of an autoencoder or a variational autoencoder.

7. The system of claim 1, wherein operations further comprise:
setting a number of epochs; and
training one of an autoencoder or a variational autoencoder by recursively repeating the operations until the number of epochs is met.

8. The system of claim 1, wherein operations further comprise segmenting the dataset.

9. The system of claim 1, wherein the distribution is represented by a histogram.

10. A system, comprising:
at least one processor; and
at least one non-transitory memory storing instructions that, when executed by the at least one processor cause the system to perform operations comprising:
receiving a dataset comprising a plurality of samples;
receiving a specified number of bins;
sending the dataset and the specified number of bins to a multilayer neural network;
generating, by the neural network, a first dimension of an output matrix comprising the specified number of bins;
calculating, by the neural network, edge values for the specified number of bins, such that the bins do not overlap;
generating, by the neural network, a second dimension of the output matrix comprising the edge values of the bins;
calculating, by the neural network, numbers of the sample values in the bins, based on edge values of the bins;
generating, by the neural network, a third dimension of the output matrix comprising the numbers sample values in the bins;
producing, by the neural network, the final output matrix; and
reconstructing, by the neural network, the distribution from the output matrix.

11. The system of claim 10, wherein the operations further comprise constructing a distribution matrix from the dataset.

12. The system of claim 11, wherein the operations further comprise comparing the reconstructed distribution with the constructed distribution.

13. The system of claim 12, wherein comparing the reconstructed distribution comprises comparing each element of the output matrix with the constructed distribution matrix.

14. The system of claim 13, wherein the operations further comprise calculating a confidence parameter based on the comparison of the elements of the output matrix with the constructed distribution matrix.

15. The system of claim 14, wherein the operations further comprise training one of an autoencoder or a variational autoencoder by recursively repeating the operations until a desired confidence parameter is met.

16. The system of claim 10, wherein operations further comprise setting a number of epochs.

17. The system of claim 16, wherein the operations are recursively repeated until the set number of epochs is met to train one of an autoencoder or a variational autoencoder.

18. The system of claim 10, wherein the distribution is represented by a histogram.

19. A method comprising:
receiving a dataset comprising integer values, floating point values, and a specified number of bins;
sending the dataset and the specified number of bins to an encoder layer of a neural network;
producing latent variables by compressing and organizing the dataset by the encoder layer;
sending the latent variables to a recurrent layer of the neural network;
generating, by the recurrent layer, edge values of the bins for the latent variables of the neural network;
sending the latent variables and generated edge values to a decoder layer of the neural network;
producing an output matrix by decoding the latent variables by the decoder layer; and
reconstructing a distribution from the output matrix by the decoder layer.

20. The method of claim 19, wherein the generating edge values further comprises:
calculating, by the recurrent layer, edge values for the specified number of bins, such that the bins do not overlap;
calculating, by the recurrent layer, amounts of samples in the bins, based on the sample values and edge values; and
producing an output matrix further comprises:
generating, by the decoder layer, a first dimension of an output matrix comprising the specified number of bins;
generating, by the decoder layer, a second dimension of the output matrix comprising edge values of the bins;
generating, by the decoder layer, a third dimension of the output matrix comprising samples of each bin.
